(19) United States
(12) Patent Application Publication
(10) Pub. No.: US 2011/0101683 A1
(43) Pub. Date: May 5, 2011

(54) VEHICLE EXHAUST DECOUPLER

(75) Inventors: Gregor Reimann, Portland, OR (US); Christopher M. Collins, Portland, OR (US)

(73) Assignee: Daimler Trucks North America LLC

(21) Appl. No.: 12/940,859

(22) Filed: Nov. 5, 2010

Related U.S. Application Data
(60) Provisional application No. 61/258,485, filed on Nov. 5, 2009.

(51) Int. Cl. F16L 25/00

(52) U.S. Cl. 285/330

(57) ABSTRACT

An exhaust conduit decoupler for a vehicle having a chassis and a cab mounted to the chassis comprises a first conduit coupled to the chassis and a second conduit coupled to the cab. The first conduit comprises an inlet portion, a tapered transition portion, and an outlet portion having a smaller inner cross-sectional area than the inlet portion. The second conduit comprises an inlet section, a tapered transition section, and an outlet section such that the inlet section has a greater inner cross-sectional area than the outlet section. The outlet portion of the first conduit extends through an inlet opening of the second conduit, is positioned within the inlet section of the second conduit and is spaced entirely from the inlet section of the second conduit by a gap.

### CROSS REFERENCE TO RELATED APPLICATION

This application claims the benefit of U.S. Provisional Patent Application No. 61/258,485, filed Nov. 5, 2009.

### FIELD

The present disclosure relates to conduit systems and more particularly to vehicle exhaust systems and components therefor that accommodate relative motion between system components during operation of the vehicle and also to vehicles with such exhaust systems.

### SUMMARY

Described herein are embodiments of vehicle exhaust systems and vehicles with such exhaust systems, wherein the exhaust systems comprise decoupling elements to accommodate relative motion between a chassis and a cab of a vehicle at locations where a chassis-mounted exhaust component or conduit joins a cab-mounted exhaust component or conduit.

In one embodiment, a vehicle exhaust conduit decoupler includes a first and a second conduit and the vehicle has a chassis and a cab mounted to the chassis. The first conduit is provided for coupling to the chassis of the vehicle and adapted for such coupling and includes an inlet portion with a first conduit inlet opening, a tapered transition portion extending from the inlet portion, and an outlet portion extending from the transition portion. The outlet portion can have a first conduit outlet opening and an inner cross-sectional area that is smaller than an inner cross-section area of the inlet portion of the first conduit. The second conduit is provided for coupling to the cab of the vehicle and adapted for such coupling and can include an inlet section with an inlet opening, a tapered transition section extending from the inlet section, and an outlet section extending from the transition section. The disclosure also contemplates the example of the first and second conduits being respectively mounted or coupled to and thereby in combination with the respective chassis and cab. The outlet section can have a second conduit outlet opening. The inlet section of the second conduit can have an inner cross-sectional area that is greater than an inner cross-sectional area of the outlet section of the second conduit. At least a portion of the outlet portion of the first conduit can extend through the inlet opening of the second conduit and can comprise an inserted portion of the outlet portion of the first conduit that is positioned within the inlet section of the second conduit and is spaced entirely from the inlet section of the second conduit by a gap.

The gap can comprise an annular gap that is sized to allow for at least some relative motion between the cab and the chassis during operation of the vehicle without contact between the first conduit and the second conduit.

The gap can also define a portion of an ambient air flow communication pathway from a location exteriorly of the first conduit, between the exterior or the first conduit and the interior of the second conduit, and to the interior of the second conduit. In such embodiments, exhaust gasses flowing through the outlet opening of the first conduit and into the inlet section of the second conduit create a low pressure region in the inlet section of the second conduit that draws ambient air through the ambient air flow communication pathway and into the interior of the second conduit.

The second conduit can be adapted for coupling to the cab so as to be substantially vertically oriented such that water running downward along an inner surface of the second conduit is conducted through the gap and out of the conduits.

An exhaust conduit interface or vehicle exhaust decoupler for a vehicle can include a first and second exhaust conduit with the vehicle including a chassis and a cab suspended on the chassis such that the cab is movable relative to the chassis during use of the vehicle. The first exhaust conduit can be coupled to the chassis with a downstream end portion. The second exhaust conduit can be coupled to an outside surface of the cab with an upstream end portion. The downstream end portion of the first exhaust conduit can be positioned within and spaced from the upstream end portion of the second exhaust conduit. Exhaust gas traveling through the first conduit exits the downstream end portion of the first conduit and enters the upstream end portion of the second conduit and flows through the second exhaust conduit.

The foregoing and other objects, features, and advantages of the invention will become more apparent from the following detailed description, which proceeds with reference to the accompanying figures.

### BRIEF DESCRIPTION OF THE DRAWINGS

FIG. 1 is a cross-sectional side view of a conduit decoupler, according to one embodiment.

FIG. 2 is a cross-sectional perspective view of the conduit decoupler of FIG. 1.

FIG. 3 is a cross-sectional side view of the conduit decoupler of FIG. 1, showing a simulation of temperatures of gas flowing through the conduits.

### DETAILED DESCRIPTION

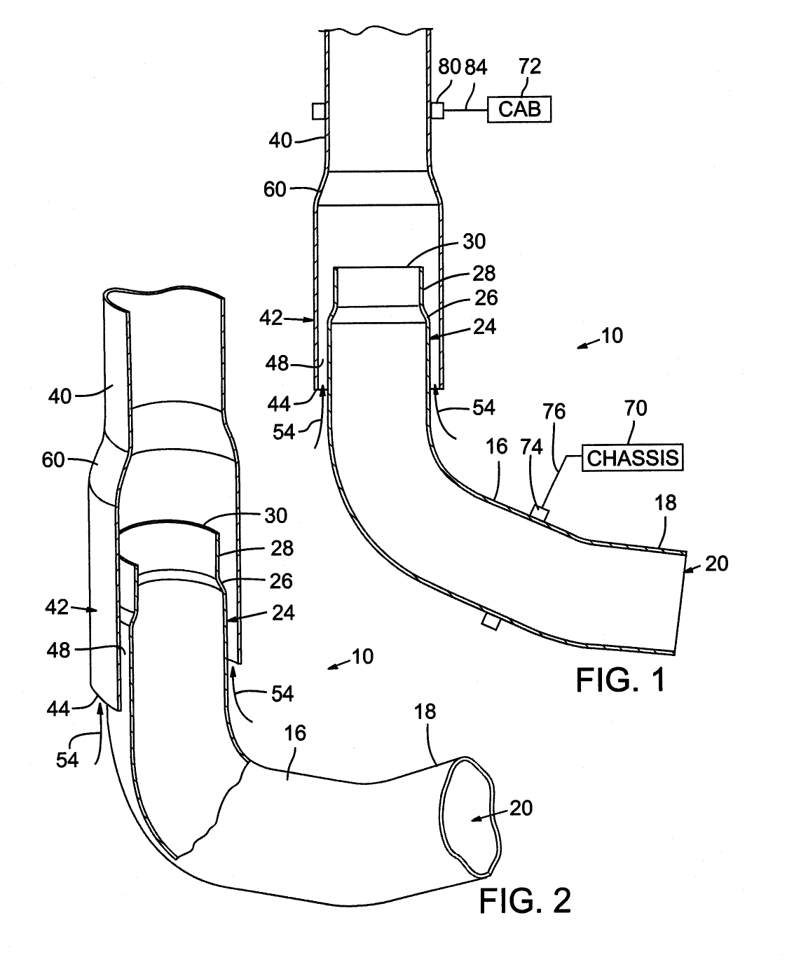

FIGS. 1 and 2 illustrate an exemplary conduit decoupler 10. The conduit decoupler 10 can, for example, comprise a portion of a vehicle exhaust system. The decoupler 10 can comprise a first conduit component 16 that is mounted to a chassis of a vehicle and a second conduit component 40 that is mounted to a cab of the vehicle. The vehicle can be, for example, a class 8 truck.

As shown in FIG. 1, the vehicle chassis is represented schematically at 70 and the vehicle cab is represented schematically at 72. One or more brackets, such as bracket 74, can surround conduit component 16 and can be mounted to chassis 70, such as indicated by a mounting strap or coupling 76. One or more brackets, such as bracket 80, can surround conduit component 40 and can be mounted to the cab 72, such as indicated be a mounting strap or coupling 84.

The cab 72 can be mounted to the chassis 70 via a suspension system that allows for relative motion between the cab and the chassis. The decoupler 10 can provide for a contact-free, or limited-contact, interface between the first and second conduit components 16, 40 in order to accommodate the relative motion between the cab and the chassis.

The first conduit component 16 comprises an upstream end portion 18 that can be coupled to other exhaust system components and/or to an engine for receiving exhaust at an input or inlet opening 20 of the component 16. A downstream end portion 24 of conduit component 16 comprises a stepped-down or tapered transition portion 26 and an outlet portion 28 having an outlet opening 30 of a smaller cross-sectional area than the inlet opening 20. As a result, exhaust gas flowing through end portion 24 is restricted and accelerates as it flows through the transition portion 26 into the outlet portion 28.

The second conduit component 40 can comprise an input or inlet end portion 42 and a stepped-down or tapered transition portion 60 having an outlet portion. The inlet portion 42 has a greater cross sectional dimension than the outer dimension of end portion 24 of the first component 16. As a result, at least a portion of the end portion 24 can be inserted into an inlet opening 44 and comprise an inserted portion of the outlet portion 24 of the first conduit 16 that is positioned within the interior of end portion 42 of the second conduit 40.

A gap, such as the annular gap 48, can be provided between the inner surface of end portion 42 and the outer surface of end portion 24 such that the components 16 and 40 are spaced entirely from one another. Because of this gap, the end portions 24 and 42 can be free to move relative to one another to some extent without contacting one another. In other embodiments, there can be limited contact between the end portions 24 and 42. The gap 48 can fluidly connect ambient air outside of conduits 16 and 40 with the exhaust within the conduits, creating an ambient air flow communication pathway from a location exteriorly of the first conduit 16, through the gap, and to the interior of the second conduit 40.

A cushioning material can be provided in the gap 48. The cushioning material can completely or partially fill the gap 48. If used, the cushioning material is desirably air-permeable so as to allow the flow of air through the gap 48 from opening 44 to the interior of conduit 40.

As exhaust gas flows from conduit component 16 through end portion 24 and into conduit component 40, supplemental cooling air, as indicated by arrows 54, is drawn into the gap 48 through opening 44 to both cool the exhaust and minimize any leakage of exhaust through opening 44. The acceleration of the exhaust as it exits outlet opening 30 can create a low pressure region within end portion 42 that assists in drawing in the cooling air.

With the above construction, the need for flexible directly contacting coupling elements, such as strip-wound metal decoupling elements, is eliminated. These latter elements are more costly, less durable and noisier due to structural vibrations between contacting exhaust pipe elements. Strip-wound metal decoupling elements also have a relatively limited life expectancy (e.g., 150,000 to 300,000 [what, miles/hours?] in some cases).

In the illustrated example, conduit component 40 also comprises a transition portion 60 downstream from end portion 42, wherein the internal diameter of the conduit component 40 is desirably reduced to be comparable to the interior diameter of conduit component 16 upstream from transition portion 26. It should be noted that transition portion 26 need not be stepped down, but can be a gradual or other transition such as shown, as can transition portion 60.

In some embodiments, the first conduit 16 can curve upwardly at its downstream end and extend into the lower end of the second conduit 40. The second conduit 40 can extend uprightly, such as vertically or at an angle from vertically, along the outside of the cab to an upper opening where the exhaust is output into the atmosphere. In some situations, liquid, such as rain water, can enter the upper opening of the second conduit 40 and run down the inner surface of the second conduit against the flow of gas due to gravity. However, liquid running downward along an inner surface of the second conduit 40 can be conducted through the gap 48 between the inner surface of the second conduit and an outer surface of the first conduit 16 and to the exterior of the conduits. This can reduce the amount of liquid that enters the first conduit, which can be harmful to the exhaust system.

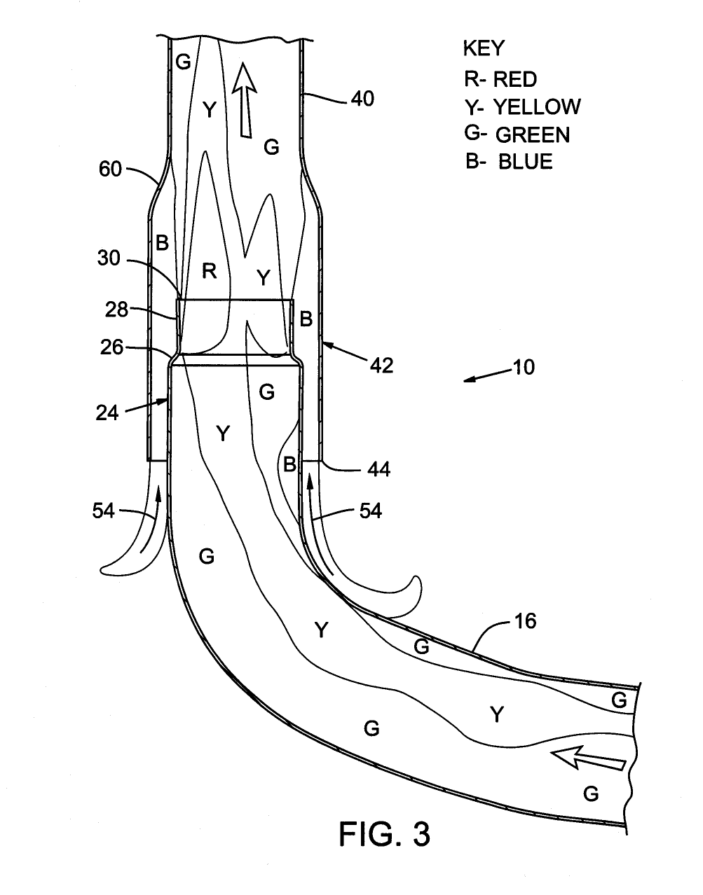

FIG. 3 illustrates a simulation of temperatures of gas flowing through the conduit components 16 and 40 with darker yellows and reds indicating higher temperature areas of exhaust and greens and blues indicating lower temperatures. As one can see from this simulation, air entering through the gap 48 assists in cooling the exhaust.

Having illustrated and described the principles of our invention with respect to exemplary embodiments, it should be apparent to those of ordinary skill in the art that the disclosed embodiments may be modified in arrangement and detail without departing from the inventive principles disclosed herein and that the illustrated embodiments are only examples of the invention and should not be taken as limiting the scope of the invention. Rather, the scope of the invention is defined by the following claims. We therefore claim as our invention all that comes within the scope and spirit of these claims.

We claim:

1. An exhaust conduit decoupler for a vehicle, the vehicle comprising a chassis and a cab mounted to the chassis, the exhaust conduit decoupler comprising:
a first conduit for coupling to the chassis of the vehicle, the first conduit comprising an inlet portion including a first conduit inlet opening, a tapered transition portion extending from the inlet portion, and an outlet portion extending from the transition portion, the outlet portion having a first conduit outlet opening, the outlet portion of the first conduit having an inner cross-sectional area that is smaller than an inner cross-section area of the inlet portion of the first conduit;
a second conduit for coupling to the cab of the vehicle, the second conduit comprising an inlet section having an inlet opening, a tapered transition section extending from the inlet section, and an outlet section extending from the transition section, the outlet section having a second conduit outlet opening, the inlet section of the second conduit having an inner cross-sectional area that is greater than an inner cross-sectional area of the outlet section of the second conduit; and
wherein when the first conduit is coupled to the chassis of the vehicle and the second conduit is coupled to the cab of a vehicle, at least a portion of the outlet portion of the first conduit extends through the inlet opening of the second conduit and comprises an inserted portion of the outlet portion of the first conduit that is positioned within the inlet section of the second conduit and spaced entirely from the inlet section of the second conduit by a gap.

2. The exhaust conduit decoupler for a vehicle of claim 1, wherein the gap comprises an annular gap that is sized to allow for at least some relative motion between the cab and the chassis during operation of the vehicle without contact between the first conduit and the second conduit.

3. The exhaust conduit decoupler for a vehicle of claim 1, wherein the gap defines a portion of an ambient air flow communication pathway from a location exteriorly of the first conduit, between the exterior or the first conduit and the interior of the second conduit, and to the interior of the second conduit.

4. The exhaust conduit decoupler for a vehicle of claim 3, wherein exhaust gasses flowing through the outlet opening of the first conduit and into the inlet section of the second conduit create a low pressure region in the inlet section of the second conduit that draws ambient air through the ambient air flow communication pathway and into the interior of the second conduit.

5. The exhaust conduit decoupler for a vehicle of claim 1, wherein the second conduit is adapted for coupling to the cab so as to be uprightly oriented such that water running downward along an inner surface of the second conduit is conducted through the gap.

6. The exhaust conduit decoupler of a vehicle of claim 1, wherein an inner cross-sectional area of the inlet portion of the first conduit is about equal to an inner cross-sectional area of the outlet section of the second conduit.

7. The exhaust conduit decoupler of a vehicle of claim 1, wherein the vehicle is a class 8 truck.

8. The exhaust conduit decoupler for a vehicle of claim 1 wherein the gap is at least partially filled with cushioning material.

9. A vehicle with an exhaust decoupler comprising:
a chassis;
a cab suspended on the chassis such that the cab is movable relative to the chassis during use of the vehicle;
the exhaust conduit decoupler comprising:
a first exhaust conduit coupled to the chassis and having a downstream end portion;
a second exhaust conduit coupled to an outside surface of the cab and having an upstream end portion; and
wherein the downstream end portion of the first exhaust conduit is positioned within and spaced from the upstream end portion of the second exhaust conduit and wherein exhaust gas traveling through the first conduit exits the downstream end portion of the first conduit and enters the upstream end portion of the second conduit and flows through the second exhaust conduit.

10. The vehicle of claim 9, wherein the second exhaust conduit is mounted to a rear surface of the cab in an upright orientation.

11. The vehicle of claim 9 wherein the second exhaust conduit is mounted to a rear surface of the cab in a substantially vertical orientation.

12. The vehicle of claim 9, wherein the first exhaust conduit is shaped and mounted to the chassis such that the first exhaust conduit curves upwardly into the second exhaust conduit.

13. The vehicle of claim 9, wherein the downstream end portion of the first exhaust conduit comprises a nozzle.

14. The vehicle of claim 9, wherein during use of the vehicle, the first exhaust conduit and the second exhaust conduit are movable relative to one another within limits without contacting one another as relative motion occurs between the chassis and the cab.

15. The vehicle of claim 9, wherein the vehicle is a class 8 truck.

16. The vehicle of claim 10, wherein liquid running downward along an inner surface of the second conduit is conducted between the inner surface of the second conduit and an outer surface of the first conduit and out of the conduits.

17. The vehicle of claim 9 wherein the space between the downstream end portion of the first exhaust conduit and the upstream end portion of the second exhaust conduit is at least partially filled with cushioning material.

18. A vehicle with an exhaust conduit decoupler for a vehicle comprising:
a chassis;
a cab mounted to the chassis;
the exhaust conduit decoupler comprising:
a first conduit coupled to the chassis of the vehicle, the first conduit comprising an inlet portion including a first conduit inlet opening, a tapered transition portion extending from the inlet portion, and an outlet portion extending from the transition portion, the outlet portion having a first conduit outlet opening, the outlet portion of the first conduit having an inner cross-sectional area that is smaller than an inner cross-section area of the inlet portion of the first conduit;
a second conduit coupled to the cab of the vehicle, the second conduit comprising an inlet section having an inlet opening, a tapered transition section extending from the inlet section, and an outlet section extending from the transition section, the outlet section having a second conduit outlet opening, the inlet section of the second conduit having an inner cross-sectional area that is greater than an inner cross-sectional area of the outlet section of the second conduit;
wherein at least a portion of the outlet portion of the first conduit extends through the inlet opening of the second conduit and comprises an inserted portion of the outlet portion of the first conduit that is positioned within the inlet section of the second conduit and spaced entirely from the inlet section of the second conduit by a gap, wherein the gap comprises an annular gap that is sized to allow for at least some relative motion between the cab and the chassis during operation of the vehicle without contact between the first conduit and the second conduit, wherein the gap defines a portion of an ambient air flow communication pathway from a location exteriorly of the first conduit, between the exterior or the first conduit and the interior of the second conduit and to the interior of the second conduit, and wherein exhaust gasses flowing through the outlet opening of the first conduit and into the inlet section of the second conduit create a low pressure region in the inlet section of the second conduit that draws ambient air through the ambient air flow communication pathway and into the interior of the second conduit; and
wherein the second conduit is adapted for coupling to the cab so as to be positioned in an upright orientation on the cab such that water running downward along an inner surface of the second conduit is conducted through the gap.

19. The vehicle of claim 18, wherein an inner cross-sectional area of the inlet portion of the first conduit is about equal to an inner cross-sectional area of the outlet section of the second conduit.
